(19) United States
(12) Patent Application Publication
(10) Pub. No.: US 2008/0219238 A1
(43) Pub. Date: Sep. 11, 2008

(54) Methods and systems for transmitting data between systems

(76) Inventor: Prabhakant Das, Streamwood, IL (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/545,832

(22) Filed: Oct. 11, 2006

Related U.S. Application Data
(60) Provisional application No. 60/840,619, filed on Aug. 28, 2006.

(51) Int. Cl. H04L 12/28

(52) U.S. Cl. 370/351

(57) ABSTRACT

A system and method for transmitting, receiving, and processing data. The method includes receiving data at a first data receiving port located in a first system. The received data is processed at a first module, which communicates with the first data receiving port. The processed data is relayed to a second module, which communicates with the first module at the first system. This communication is independent of a software protocol. The data is transmitted from the second module using a data transmitting port. The transmitted data is received at a second system and then further processed at the second system.

### CROSS-REFERENCE TO RELATED APPLICATIONS

This application claims a priority benefit to provisional application Ser. No. 60/840,619, filed on Aug. 28, 2006 and entitled “Bypassing Protocol Stacks in Image Processing,” which is hereby incorporated by reference in its entirety herein.

### BACKGROUND

1. Field of the Invention

The present invention relates generally to transmitting data between two or more systems. More particularly, the present invention relates to transmitting image data through a communication controller, thereby bypassing a layer of protocol stacks and increasing the efficiency of data transmission.

2. Background Discussion

The Ethernet is a family of frame-based computer networking technologies for local area networks (LANs), which has been standardized as Institute of Electrical and Electronics Engineers (IEEE) 802.3. It utilizes star-topology and twisted pair wiring form, which largely replaced LAN standards such as coaxial cable, token ring, FDDI, and ARCNET.

Above the physical layer, Ethernet stations communicate with each other by sending each other data packets, which are small blocks of data that are individually sent and delivered. As with other IEEE 802 LANs, each Ethernet station is given a single 48-bit media access controller (MAC) address, which is used both to specify the destination and the source of each data packet. Network interface cards (NICs) or chips normally do not accept packets addressed to other Ethernet stations. Adapters are generally programmed with a globally unique address, which can be overridden either to avoid an address change when an adapter is replaced or to use locally administered addresses.

Currently the Ethernet has many varieties that vary both in speed and physical medium. Some of the most common forms include 10BASE-T, 100BASE-T, and 1000BASE-T. All three of these forms utilize twisted pair cables and 8P8C modular connectors. They run at 10 Mbit/s, 100 Mbit/s, and 1 Gbit/s, respectively.

Fiber optic variants of Ethernet are commonly used to connect buildings or network cabinets in different parts of a building. The advantages of fiber optic Ethernet lie in performance, electrical isolation and distance, up to tens of kilometers with some versions.

The Ethernet uses a shared bus topology; therefore multiple computers share access to a single medium. While a computer transmits a frame, it has the exclusive use of the entire bus and all other computers must wait. After the computer finishes the transmission, the shared bus becomes available for others to use.

Unfortunately, conventional transmission systems transmit data from one system (such as an acquisition system) to another system (such as a receiving system) by transmitting data from an acquisition module of the acquisition system through one or more software layer(s) and one or more application software layer(s) of the acquisition system. The data is then routed through the device driver(s) of the acquisition system before being sent to the receiving system. The data is then routed through the application software layer(s) of the receiving system as well as the software layer(s) and device drivers of the receiving system before it reaches a processing module in the receiving system.

Therefore, it would be an advancement in the state of the art to provide a system that transmits data from an acquisition module of an acquisition system to a processing module of the receiving system while bypassing software protocols.

### BRIEF SUMMARY OF THE INVENTION

The present invention is directed to an improved method and system that transmits data from a module of an acquisition system to a module of the receiving system.

Accordingly, one embodiment of the present invention relates to a method for processing data. The method includes receiving data at a first data receiving port located in a first system. The received data is processed at a first module, which communicates with the first data receiving port. The processed data is relayed to a second module, which communicates with the first module at the first system. This communication is independent of a software protocol. The data is transmitted from the second module using a data transmitting port.

Another embodiment is directed to the above-described method (hereinafter, “the method”) and also includes receiving the transmitted data at a second system and processing the data at the second system.

Yet another embodiment is directed to the method and also includes receiving the transmitted data at a second data receiving port, which communicates with a third module at the second system; and the received data is transmitted to a fourth module communicating with the third module at the second system. The communication is performed independent of a second software protocol. The data is then processed at the fourth module.

Yet another embodiment of the present invention is directed to the method and also includes outputting the processed data at the second system.

Yet another embodiment of the present invention is directed to the method where the first module is a software layer and the second module is a software layer.

Yet another embodiment of the present invention is directed to the method where the first module is a device driver and the second module is a device driver.

Yet another embodiment of the present invention is directed to the method where the second module is a component of the first module.

Yet another embodiment of the present invention is directed to a data transmitter. The transmitter has a first data receiving port adapted to receive data. A first module communicates with the first data receiving port and processes the received data. A second module communicates with the first module and is adapted to relay the processed data from the first module independent of a software protocol. A data transmitting port is coupled to the second module and is adapted to transmit the relayed data.

Yet another embodiment of the present invention is directed to the data transmitter described above where the second module is mounted on the first module.

Yet another embodiment of the present invention is directed to a data receiver that has a data receiving port adapted to receive transmitted data. A relay module communicates with the data receiving port and is adapted to relay the received data independent of a software protocol. A processing module communicates with the relay module and is adapted to process the relayed data.

Additional embodiments of the present invention include the methods described above implemented using apparatus or programmed as computer code to be executed by one or more processors operating in conjunction with one or more electronic storage media.

### BRIEF DESCRIPTION OF THE DRAWINGS

To the accomplishment of the foregoing and related ends, certain illustrative aspects of the invention are described herein in connection with the following description and the appended drawings. These aspects are indicative, however, of but a few of the various ways in which the principles of the invention may be employed and the present invention is intended to include all such aspects and their equivalents. Other advantages and novel features of the invention may become apparent from the following description of the invention when considered in conjunction with the drawings. The following description, given by way of example, but not intended to limit the invention solely to the specific embodiments described, may best be understood in conjunction with the accompanying drawings, in which:

FIG. 1 shows a diagram to transfer data from a first system to a second system;

FIG. 2 shows a diagram to transfer data from a first system to a second system according to an embodiment of the present invention;

FIG. 3 shows a diagram to transfer data from a first system to a second system according to another embodiment of the present invention;

FIG. 4 shows a diagram to transfer data from a first system to a second system according to yet another embodiment of the present invention;

FIG. 5 shows a diagram to transfer data from a first system to a second system according to yet another embodiment of the present invention; and

FIG. 6 shows a flowchart of steps to implement an embodiment of the present invention.

### DETAILED DESCRIPTION OF THE INVENTION

It is noted that in this disclosure and particularly in the claims and/or paragraphs, terms such as “comprises,” “comprised,” “comprising,” and the like can have the meaning attributed to it in U.S. patent law; that is, they can mean “includes,” “included,” “including,” “including but not limited to” and the like, and allow for elements not explicitly recited. Terms such as “consisting essentially of” and “consists essentially of” have the meaning ascribed to them in U.S. patent law; that is, they allow for elements not explicitly recited, but exclude elements that are found in the prior art or that affect a basic or novel characteristic of the invention. These and other embodiments are disclosed or are apparent from and encompassed by, the following description.

The present invention is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

As used in this application, the terms “component” and “system” are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

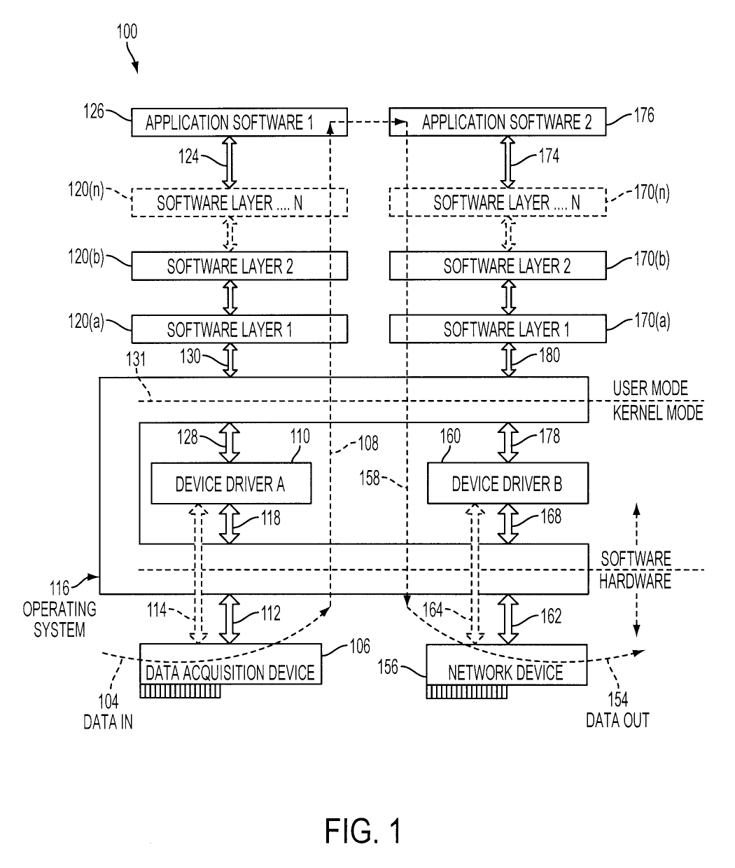

FIG. 1 shows a diagram 100 of an acquisition system with hardware and software components. For example, data acquisition device, or module, 106, is a hardware component, which has one or more data ports, such as Ethernet, USB, or Gigalink ports, that receive input data 104. The data acquisition device 106 typically includes an acquisition facility, or module, and a circuit board, such as a COPRA™ board. (COPRA™ is a trademark of Siemens Corporation). The acquisition device 106 is in bi-directional communication with operating system 116, such as WINDOWS™, via transmission medium 112. Transmission medium 112 is, for example, a wire connection, communication bus, such as an IEEE bus, or other data transmission medium suitable to transmit data signals or pulses that represent the output from the acquisition device 106 to operating system 116.

Similarly, transmission medium 114, which is for example, a wire connection, communication bus, such as an IEEE bus, or other data transmission medium suitable to transmit data signals or pulses that represent the output from the acquisition device 106, provides a transmission path from data acquisition device 106 to transmit, or communicate, data to device driver 110. Also, transmission medium 118 provides a bi-directional data path between device driver 110 and operating system 116.

Transmission medium 128 provides bi-directional data transfer between device driver 110 and operating system 116. Driver 110 is, for example, a COPRA™ driver. Transmission medium 130 provides bi-directional data transfer between operating system 116 and software layer 120(a). There may be additional software layers 120(b) . . . (n) (where “n” is any suitable number of software layers that can be supported by system 100. Software layers 120(a) . . . (n) are generally referred to as 120 herein.) Transmission medium 124 provides a bi-directional data transmission path between software layer(s) 120 and application software module 126.

Line 108 shows that data 104, received at a port of data acquisition device 106, is transmitted through, or accessed by, the above-described components of system 100. The data 104, which was received by acquisition device 106, is transmitted to a second portion of system 100, via application software module 176.

The data, shown as line 158, is transmitted through, or accessed by, the various components of system 100 described above. For example, transmission medium 174 provides a bi-directional data transmission path between application software module 176 and software layer(s) 170(a) . . . (n) (where “n” is any suitable number of software layers that can be supported by system 100. Software layers 170(a) . . . (n) are generally referred to as 170 herein.) Transmission medium 180 provides a bi-directional data transmission path between software layer(s) 170 and operating system 116.

Transmission medium 178 provides a bi-directional data transmission path between operating system 116 and device driver 160. Transmission medium 168 provides a bi-directional data transmission path between device driver 160 and operating system 116. Driver 160 is typically a driver for network device 156. Transmission medium 162 provides a bi-directional data transmission path between operating system 116 and network device 156. Network device 156 can be an Ethernet control module, described in greater detail below. Transmission medium 164 provides a bi-directional data transmission path between device driver 160 and network device 156.

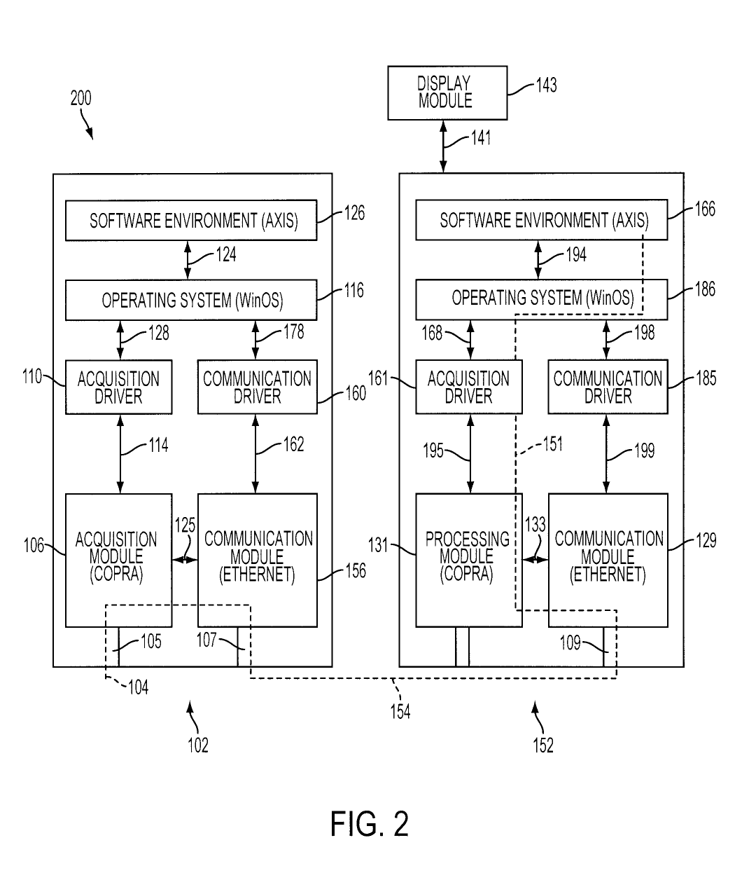

The network device 156 outputs data 154, via a port, such as an Ethernet port, a USB port, or a Gigalink port. This output 154 is typically transmitted to another system, which is adapted to receive the output 154. An embodiment showing both the transmission system and the receiving system is illustrated in FIG. 2.

FIG. 2 is an embodiment of the present invention in which data 104, such as image data, text data, or voice data, is transmitted via a transmission means, or transmission medium, such as a bus (e.g., a bus adapted to transmit data according to IEEE standard 802.11), cable, wire, data line, DSL, or other data transmission media to a data acquisition port 105, which is typically mounted on a board 106, such as a COPRA™ board. (COPRA™ is a trademark of Siemens Corporation). The received data is processed on the board 106. This processing includes performing a matching operation so that the data may be transmitted to a network card without utilizing additional protocol translations. The protocols are accessed by a controller such as an Ethernet controller.

An example of an Ethernet controller is the Intel® 82540EM Gigabit Ethernet controller, which is a single, compact component with integrated Gigabit Ethernet MAC and PHY layer functions. The 82540EM is typically packaged in 15×15 mm, and is footprint compatible with the Intel® 82551QM and 82551ER Fast Ethernet Controllers (same package size, same number and pattern of pins, and similar signal layout), allowing for a flexible, Gigabit Ethernet or 10/100 Ethernet design.

Another example of an Ethernet controller is the Broadcom® BCM5751 that is designed for use with a desktop computer and/or workstation PC, and provides sufficient processing characteristics, functionality, and speed.

FIG. 2 shows a diagram 200 of data reception, processing, transmission, and subsequent reception. System 200 includes subsystems 102 and 152. Subsystem 102 receives input data 104 at port 105. Port 105 is, for example, an Ethernet port, a USB port, a Gigalink port, or other data port suitable to receive electronic data. The data 104 is received in acquisition module 106, which may comprise an acquisition board and a COPRA™ board. The acquisition module 106 is in bi-directional communication with a communication module (such as an Ethernet module) 156, via transmission medium 125. The received input data 104 is transmitted, or communicated to communication module 156, as shown by data line 158. The data 158 is output from communication module 156 via port 107, as output data 154.

Driver 110, operating system 116 (such as, Windows™ OS), software environment (such as AXIS™ environment) 126, as well as associated transmission media 114, 128, 124, 178 and 162 are also shown in FIG. 2. (AXIS™ is a trademark of Siemens Corporation.)

Output data 154 is transmitted to a receiving module, or facility, 152 where it is input to communication module (such as an Ethernet module) 129, via port 109. The communication module 129 is in bi-directional communication with processing module (such as a COPRA™ module) 131 via transmission, or communication medium 133. Driver 161 is in bi-directional communication with the processing module (such as the COPRA™ module) 131 via transmission, or communication, medium 195 and operating system (such as WINDOWS™) 186 via transmission medium 168. Operating system 186 is in bi-directional communication with software environment (such as AXIS™ environment) 166 via transmission, or communication, medium 194. Display module 143 is in bi-directional communication with subsystem 152 via transmission medium 141.

Display module, or output display, 143 is, for example, a monitor, LCD (liquid crystal display), a plasma screen, or other graphical user interface that can display output data. Also, the image display module 143 may be coupled to another CPU, processor, or computer, such as a desktop computer or a laptop computer (not shown) and may also be coupled to a keyboard, a mouse, a track ball, or other input device (not shown) to adjust the view, dimensions, color, font, or display characteristics of the display module 143.

Data 154 from subsystem 102 is received at port 109 of communication module (such as Ethernet module) 129. The data is transmitted to a processing module (such as a COPRA™ module) 131, driver 161, operating system 186, and software environment 166, and provided to display module 143.

Components such as driver 185 and transmission media 198 and 199 perform their respective functions.

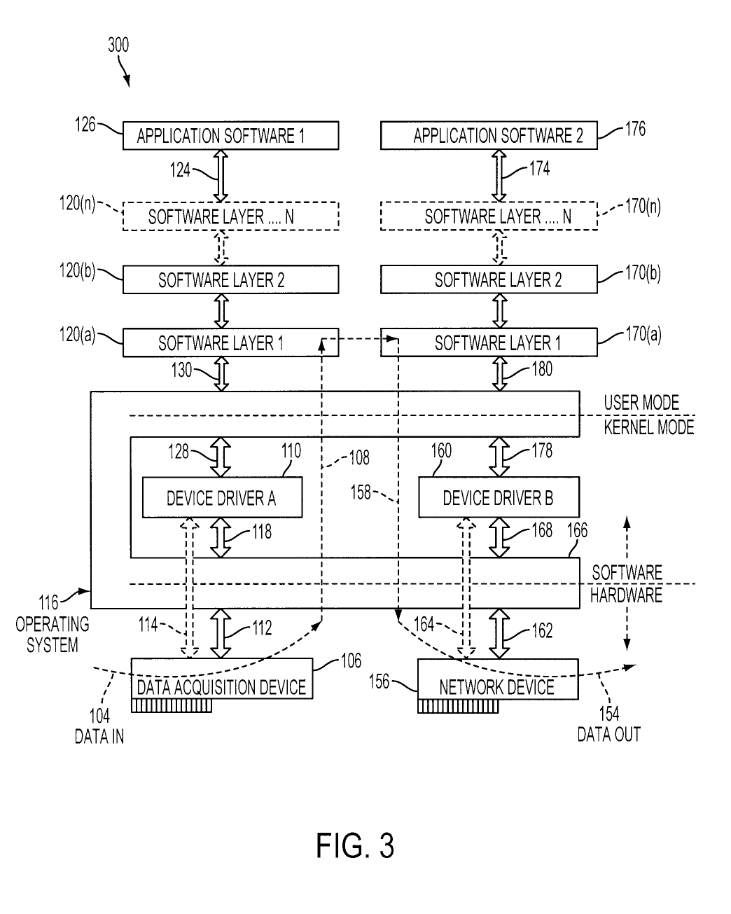

FIG. 3 shows a diagram to process and transfer data from a first system to a second system. FIG. 3 shows the details of the transmitting side only; the receiving side is similarly constructed. That is, system 300 of FIG. 3 corresponds to transmitting sub-system 102 of FIG. 2.

FIG. 3 shows system 300 which utilizes a communication module (such as an Ethernet board or network device) to receive and transmit data. The system 300 is comprised of hardware components and software components. For example, a data acquisition device, or module, 106, which has one or more data ports, such as an Ethernet port, a USB port, or a Gigalink port, receives input data 104. The data acquisition device 106 is in bi-directional communication with operating system 116 via transmission medium 112.

Similarly, transmission medium 114 provides a transmission path from data acquisition device 106 to device driver 110. Also, transmission medium 118 provides a bi-directional data path between device driver 110 and operating system 116.

Transmission medium 128 provides bi-directional data transfer between device driver 110 and operating system 116. Transmission medium 130 provides bi-directional data transfer between operating system 116 and software layer 120(a). There may be additional software layers 120(b) . . . (n) (where “n” is any suitable number of software layers that can be supported by system 102. Software layers 120(a) . . . (n) are generally referred to as 120 herein.) Transmission medium 124 provides a bi-directional data transmission path between software layer(s) 120 and application software module 126.

Line 108 shows that data 104, which was received at a port of data acquisition device 106, is transmitted through, or accessed by, the operating system 116, device driver 110 and software layer 120(a). The data 104 is then transmitted to software layer 170(a).

The received data, shown as line 158, is transmitted from software layer 170(a) to device driver 160, operating system 166, and network device 156. Data 154 is output from a port of network device 156. The output 154 may be provided to a receiving unit, as described in relation to FIG. 2. Alternatively, the output 154 may be stored or transmitted to a remote location via a wire transmission medium, wireless transmission medium, network, DSL or the Internet.

Other components of system 300 include, for example, transmission medium 174, application software module 176, software layer(s) 170(a) . . . (n), transmission medium 180, transmission medium 178, and transmission media 162 and 164, which have been described above in relation to FIG. 1.

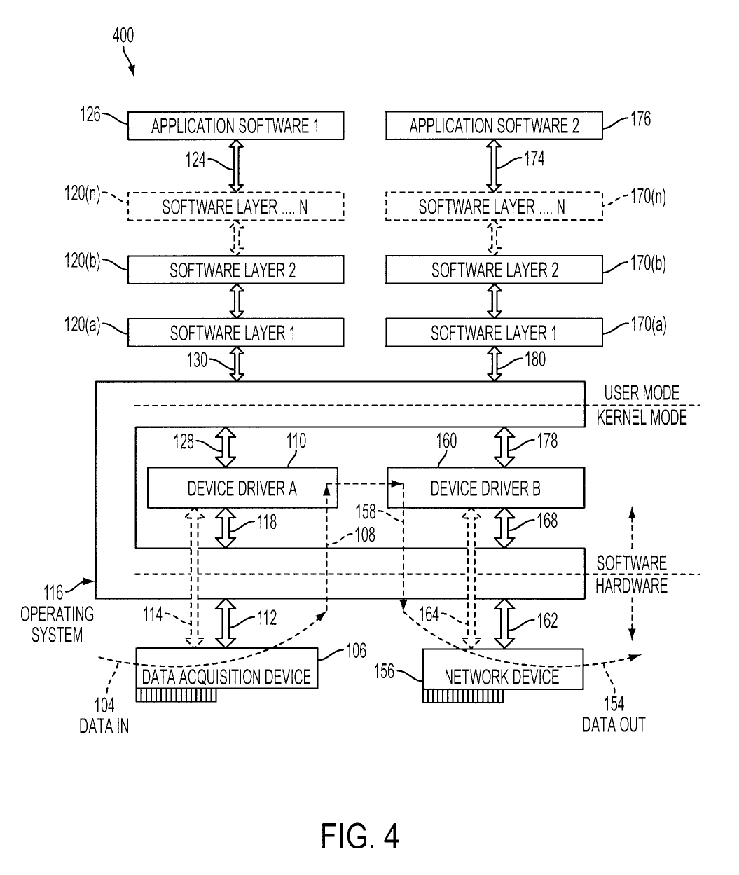

FIG. 4 shows a diagram 400 to process and/or transfer data from a first system to a second system according to another embodiment of the present invention. FIG. 4 shows hardware components and software components. For example, data acquisition device, or module, 106, which has one or more data ports, such as Ethernet, USB, or Gigalink ports, that receive input data 104. The data acquisition device 106 is in bi-directional communication with operating system 116 via transmission medium 112.

Transmission medium 114 provides a transmission path from data acquisition device 106 to device driver 110. Also, transmission medium 118 provides a bi-directional data path between device driver 110 and operating system 116.

Transmission medium 128 provides bi-directional data transfer between device driver 110 and operating system 116. Transmission medium 130 provides bi-directional data transfer between operating system 116 and software layer 120(a). There may be additional software layers 120(b) . . . (n) (where “n” is any suitable number of software layers that can be supported by system 102; software layers 120(a) . . . (n) are generally referred to as 120 herein.) Transmission medium 124 provides a bi-directional data transmission path between software layer(s) 120 and application software module 126.

Line 108 shows that data 104, which was received at a port of data acquisition device 106, is transmitted through, or accessed by, the operating system 116 and the device driver 110. The data 104 is then transmitted to device driver 160.

The received data, shown as line 158, is transmitted from device driver 160 to operating system 166 and network device 156. Data 154 is output from a port of network device 156.

Other components, for example, transmission medium 174, application software module 176, software layer(s) 170(a) . . . (n), transmission medium 180, transmission medium 178, and transmission media 162 and 164 have been described above in relation to FIG. 1.

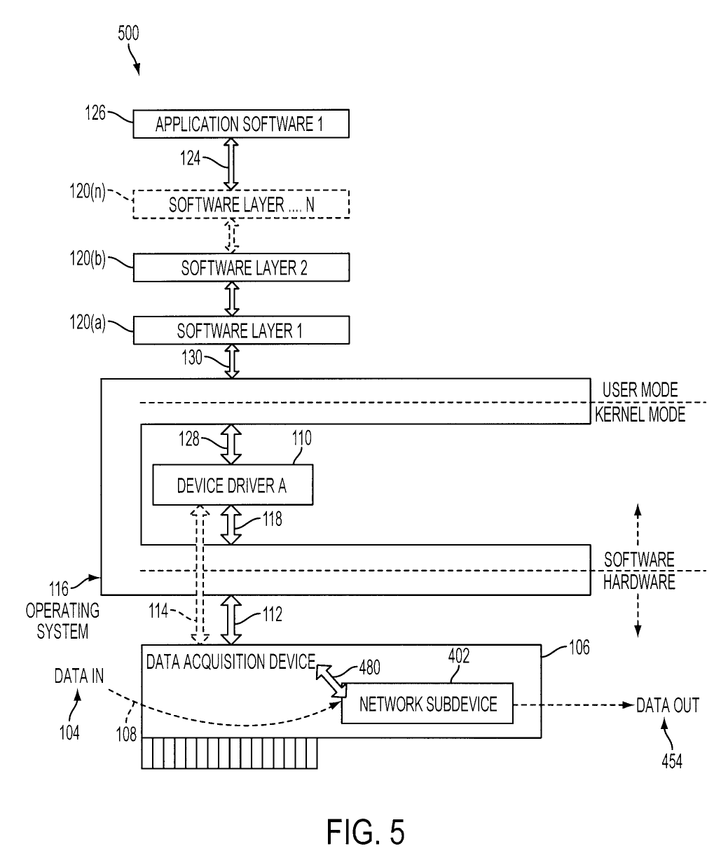

FIG. 5 shows a diagram 500 to transfer data using a communication module (such as an Ethernet controller) 402, which is disposed on a circuit board, which may be, for example, a COPRA™ board. Received data 104 is processed and output as output data 454.

More specifically, data acquisition device, or module, 106, which has one or more data ports, such as an Ethernet, USB, or Gigalink port, receives input data 104. The data acquisition device includes a controller, or network sub-device (such as an Ethernet controller) 402 mounted on the device 106. Line 108 shows that received data 104 is provide to controller 402. Bi-directional transmission medium 480 is, for example, a wire connection, communication bus, such as an IEEE bus, or other data transmission medium suitable to transmit data signals or pulses that represent the output from the acquisition device 106 to controller 402. Transmission medium 112 provides bi-directional communication between data acquisition device 106 and operating system 116. Thus, FIG. 5 shows that data is transmitted through a controller (such as an Ethernet controller) 402, thereby bypassing a layer of protocol stacks 110, 116, 120(a) . . . (n), and 126, and increasing the efficiency of transmission.

The remaining components and elements of FIG. 5 have been described previously in relation to FIGS. 1, 3, and 4.

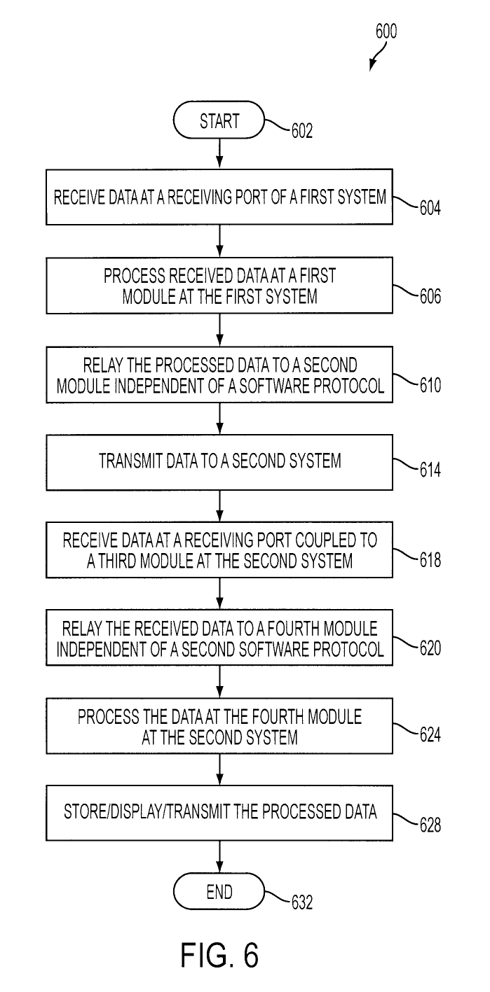

FIG. 6 shows a flowchart 600 of steps to implement an embodiment of the present invention. The processing steps 600 may be stored on, and/or retrieved from, an electronic medium such as RAM, ROM, or cache memory. It may also include recorders to record to and read from mass storage devices such as, for example, optical disks, magnetic disks, flash semiconductor disks, and other types of storage which may be temporary or permanent.

The process is started, as shown in step 602. Data is received at a data receiving port located in a first system, as shown in step 604. (An example of this port is shown in FIG. 2 as port 105.) The received data is processed at a first module, which communicates with the first data receiving port, as shown in step 606. (An example of the first module is acquisition module 106, shown in FIG. 2.) The processed data is relayed to a second module, which communicates with the first module at the first system. (An example of the second module is communication module 156, shown in FIG. 2.) This communication is independent of a software protocol, as shown in step 610, and as described in detail with relation to FIGS. 2-5. The data is transmitted from the second module using a data transmitting port, as shown in step 614. (An example of the data transmitting port is port 107, shown in FIG. 2.)

The transmitted data is received at an input port of the second system, as shown in step 618. (An example of the input port is port 109 of second sub-system 152, as shown in FIG. 2.) The input port of the second system is typically operatively coupled to, or in communication with, a third module at the second system. (An example of the third module is communication module 129, shown in FIG. 2.) The received data is relayed, or transmitted to, a fourth module, as shown in step 620. This transmission is independent of a software protocol as described in detail with relation to FIGS. 2-5. (An example of the fourth module is processing module 131 shown in FIG. 2.)

The data is processed at the fourth module, as shown in step 624. Step 628 shows that the processed data may be stored, displayed, or transmitted to a remote location. This transmission may be via modem, DSL line, network; LAN, the Internet, or wireless transmission media. Step 632 shows that the process ends.

It will be appreciated from the above that the invention may be implemented as computer software, which may be supplied on a storage medium or via a transmission medium as a network or the Internet.

Although embodiments of the invention have been described in detail, it should be understood that various changes, substitutions, and alterations can be made therein without departing from the spirit and scope of the invention as defined by the appended claims.

What is claimed is:

1. A method for processing data, comprising:
receiving data at a first data receiving port located in a first system;
processing the received data at a first module communicating with the first data receiving port;
relaying the processed data to a second module communicating with the first module at the first system, independent of a software protocol; and
transmitting the data from the second module using a data transmitting port.

2. The method according to claim 1, further comprising:
receiving the transmitted data at a second system; and
processing the received data at the second system.

3. The method according to claim 1, further comprising:
receiving the transmitted data at a second data receiving port communicating with a third module at a second system;
relaying the received data to a fourth module communicating with the third module at the second system, independent of a second software protocol; and
processing the data at the fourth module.

4. The method according to claim 3, further comprising:
outputting the processed data at the second system.

5. The method according to claim 1, wherein the first module is a software layer and the second module is a software layer.

6. The method according to claim 1, wherein the first module is a device driver and the second module is a device driver.

7. The method according to claim 1, wherein the second module is a component of the first module.

8. A data transmitter, comprising:
a first data receiving port adapted to receive data;
a first module, communicating with the first data receiving port, adapted to process the received data;
a second module, communicating with the first module, adapted to relay the processed data from the first module independent of a software protocol; and
a data transmitting port, coupled to the second module, adapted to transmit the relayed data.

9. The transmitter according to claim 8, wherein the first module is a software layer and the second module is a software layer.

10. The transmitter according to claim 8, wherein the first module is a device driver and the second module is a device driver.

11. The transmitter according to claim 8, wherein the second module is a component of the first module.

12. A data receiver, comprising:
a data receiving port adapted to receive transmitted data;
a relay module, communicating with the data receiving port, adapted to relay the received data independent of a software protocol; and
a processing module, communicating with the relay module, adapted to process the relayed data.

13. The receiver according to claim 12, further comprising:
an output module adapted to output the processed data.

14. An apparatus for processing data, comprising:
means for receiving data at a first data receiving port;
means for processing the received data at a first module communicating with the first data receiving port;
means for relaying the processed data to a second module communicating with the first module, independent of a software protocol; and
means for transmitting the data from the second module using a data transmitting port.

15. A system for processing data, comprising:
at least one memory; and
at least one processor, coupled to the at least one memory, said at least one processor adapted to executed program code to:
receive data at a first data receiving port;
process the received data at a first module communicating with the first data receiving port;
relay the processed data to a second module communicating with the first module, independent of a software protocol; and
transmit the data from the second module using a data transmitting port.

16. A system for processing data, comprising:
at least one memory; and
at least one processor, coupled to the at least one memory, said at least one processor adapted to executed program code to:
receive the transmitted data at a second data receiving port communicating with a third module;
relay the received data to a fourth module communicating with the third module, independent of a second software protocol; and
process the data at the fourth module.
